(19) United States
(12) Patent Application Publication
(10) Pub. No.: US 2022/0003646 A1
(43) Pub. Date: Jan. 6, 2022

(54) CONNECTION TEST APPARATUS

(71) Applicant: GREEN MONSTER OFFSHORE PTY LTD., Henderson (AU)

(72) Inventor: Gus COSTAS, Henderson (AU)

(21) Appl. No.: 17/474,398

(22) Filed: Sep. 14, 2021

Related U.S. Application Data
(63) Continuation of application No. PCT/AU2020/050250, filed on Mar. 16, 2020.

(30) Foreign Application Priority Data
Mar. 15, 2019 (AU) 2019900872

(51) Int. Cl. G01N 3/10

(52) U.S. Cl. CPC G01N 3/10; G01N 2203/0252; G01N 2203/0048; G01N 2203/0017

(57) ABSTRACT

A connection point test apparatus for testing the strength of an association of a connection point (or similar) to an object is disclosed. In one embodiment, the connection point test apparatus includes a body, the body having a surface configured for placement against a surface of the object so that force applied by the body to the surface can be reacted against during operation of the apparatus. The apparatus includes a load transfer assembly operable within a profile of the body, and releasably connectable to the connection point associated with the object. The load transfer assembly is configured operable with the body for generating a force for transfer to the connection point for testing its association to the object. The body is configured so that a portion thereof defines a chamber internal of the body for accommodating a fluid which, when placed under pressure, renders the load transfer assembly operable.

### CROSS REFERENCE TO RELATED APPLICATIONS

This application is a continuation of PCT/AU2020/050250, filed Mar. 16, 2020, which claims priority from AU Patent Application No. 2019900872, filed Mar. 15, 2019, the disclosures of which are incorporated herein by reference in their entireties.

### TECHNICAL FIELD

In at least one aspect, a connection point test apparatus is disclosed. In one embodiment, for example, a lift point test apparatus is disclosed. In another embodiment, a pad eye test apparatus is disclosed.

### BACKGROUND

Lifting lugs such as pad eyes are primarily used as attachment points for rigging for the purpose of hoisting, transporting, or securing heavy equipment. Such attachment points are usually welded either to the equipment or to some device on which the equipment is transported. The strength of the connection (often welds) between the attachment point and its host equipment cannot be easily/readily tested after manufacture. For the case of welds, the only indication of weakness is discovered on complete failure of the attaching weld.

Regulatory standards require that attachment points meet specific criteria. However, it is often difficult to test the structural capacity of the attachment points. In some cases, such as for marine applications, for example, it can be difficult to access locations of attachment points for substantive testing in a safe and reliable manner.

It is against this general background that the embodiments described herein have been developed.

It is to be understood that each document, reference, patent application or patent cited in this text is expressly incorporated herein in their entirety by reference, which means that it should be read and considered by the reader as part of this text. That the document, reference, patent application, or patent cited in this text is not repeated herein is merely for reasons of conciseness.

Furthermore, in this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive concept/principles may be exemplified.

### SUMMARY OF INVENTION

According to a first principal aspect, there is provided a connection point test apparatus for testing the strength of an association of a connection point (or similar) to an object, the apparatus comprising:
a body, the body having a surface configured for placement against a surface of the object so that force applied by the body to the surface of the object can be reacted against during operation of the apparatus,
a load transfer assembly operable within a profile of the body, and releasably connectable to the connection point associated with the object, the load transfer assembly configured operable with the body for generating a force for transfer to the connection point for testing its association to the object,
the body configured so that a portion thereof, cooperatively with the load transfer assembly, defines a chamber internal of the body for accommodating a fluid which, when placed under pressure, renders the load transfer assembly operable.

A connection point in the context of the description herein comprises, non-exhaustively, an item used for the purpose of serving as, in part, a point of attachment associated with an object for handling purposes (such as for example, when handling large heavy objects using specific handling equipment/machinery). Such connection points may comprise, for example: attachment points, coupling points, lifting points, restraints formed with, having or which are coupled to attachment points, and pad-eyes. The skilled reader would readily appreciate other types of arrangements that could be used for the purposes of providing such a connection point when handling heavy objects, equipment, structures, machinery and the like. For convenience of explanation herein, reference to a connection point will be made by way of reference to a ‘pad-eye’, as this form of connection point exists in the technical art.

Related to the type of connection point is the means by which it is associated with the object. Such forms of association could be, for example, nut/bolt fastening arrangements, welding techniques/processes, webbing elements from which restraints are formed from which are coupled to a connection point having an eyelet or loop, for example. The skilled reader would appreciate other types of ways in which a connection point or eyelet may be coupled to an object for allowing the object to the handled.

In some specific forms, the apparatus may be exemplified in the form of a ‘pad-eye’ load tester. As the skilled reader would readily appreciate, a pad-eye is a small usually round aperture or opening (eg. eyelet, loop) that is in an edgewise projection of a member (for example, a plate or similar construction) welded or otherwise fixed (by way of a suitable fastening system such as nut/bolt system or welding techniques/processes) to a part of a structure/object and that is used like an eyebolt as a catch (as for example, hooks) or other point of attachment (as for, for example, rigging). Pad eyes are generally attached to a mass/object that is to be handled in some manner, for example, being moved/lifted from a first location to a second location. Such objects are generally too heavy for safe handling by humans, and therefore require the use of handling equipment, such as for example, a crane/hoist system. A pad-eye (and like attachment items) are generally connected to the relevant mass so as to provide a connection point for a rope or wire element, said rope/wire element being connected to the handling equipment. In this manner, once connected via an arrangement of rope/wires (one or more as the case may be) the object can be handled by operation of the handling equipment.

However, for safety purposes, pad-eyes and like load bearing items require testing (usually in a regular manner in an on-going basis) to ensure that it remains capable of withstanding a threshold load. Specifically, it is the structural capacity of the connection that connects the pad eye to the host object that is the primary consideration for testing. Of course, testing will be carried out following installation to a host object, but it is accepted that over time, the initial load capacity of the pad-eye can reduce. For example, the environment that a pad-eye operates in can inherently reduce the potential load capacity over time. As one example, pad-eyes operating in a marine environment may be susceptible to corrosion over time. Additionally, if not maintained in an appropriate manner, environmental impacts can be significantly detrimental. Of course, fabrication material and other factors influence the on-going load capacity of such items.

Embodiments of the above described principal aspect, and those described below, may comprise any of the following features (either separately or in combination).

In one embodiment, the body is a single or a unitary body. However, in other embodiments, the body is defined by more than one body portions which when assembled provide a body capable of operating in accordance with the principles described herein.

In one embodiment, the body is of cylindrical or tubular form either when formed of a single unitary part, or when comprised of more than one body portion.

In one embodiment, the body is of cylindrical form and formed concentric about a longitudinal axis of the apparatus.

In one embodiment, the profile of the body, in at least one form, is one defined by the periphery of an exterior of the body.

In one embodiment, the body comprises a bore extending therethrough.

In one embodiment, one or more portions of the bore of the body operate to, in part, define the chamber. In this manner, the chamber cooperates with componentry of the load transfer assembly in providing an integrated pressurisable fluid chamber for use in developing a load of sufficient magnitude to load test pad eye and like items.

In one embodiment, the body cooperates with the load transfer assembly to provide a fluidly sealed chamber sufficient for accommodating fluid subject to a pressure, or increasing pressure.

In one embodiment, the volume of the chamber cooperatively defined by the body and the load transfer assembly can increase as the pressure of the fluid increases, and one or more components of the load transfer assembly moves in response to the pressurised fluid.

Advantageously, in at least one embodiment, the integrated nature of the body assists in allowing the apparatus to exemplify a reduced profile as compared existing equipment. In this manner, with the chamber being, in part, defined by internal portions of the body, operational reliance of the apparatus is not placed on the use of third party hydraulic (or in some cases, pneumatic) ram arrangements. Thus, such integration of the chamber within the body of the apparatus allows the apparatus to confer advantage in weight (for example, allowing ease of handling), space (for example, allowing convenience in packaging, storage), and/or cost (less expense required for purchasing off the shelf hydraulic components). Furthermore, with a reduced overall profile, embodiments of the apparatus can be used to safely test pad eyes that may be difficult to access using conventional load testing equipment.

In one embodiment, the reduced profile and/or form of the apparatus, by way of at least the incorporation of the chamber in the body, allows the apparatus to be operated easily (relative to conventional equipment) by a single person. Conventional equipment requiring additional/separate componentry to operate can be difficult to operate safely with less than two people, as the additional/separate equipment needed to be individually positioned and operated while the host equipment is also positioned appropriately. In this regard, embodiments drawing on the principles described herein are directed to providing an arrangement that is orientated around safe use.

In one embodiment, the body of the apparatus is configured so as to provide a first end configured for allowing the body to abut against a surface of an object to which the pad-eye is connected to (generally by way of welding processes/techniques and the like).

In one embodiment, the first end of the body comprises a generally uniform or flat face so as to abut against a surface of the object hosting the pad eye during use.

In one embodiment, an end of the apparatus is configured so as to provide a handle, for allowing the apparatus to be portable (for example, carried by a user). Furthermore, the handle may be configured so that the apparatus can be manipulated as appropriate (for example, when testing pad eyes that may be located or positioned in places that are difficult to access).

In one embodiment, the handle is operably associated with the load transfer assembly for allowing adjustment of the apparatus (eg. for differing geometries of pad eye configurations).

In one embodiment, the handle is of tubular form having an interior surface region.

In one embodiment, the exterior of the handle is dimensioned so as to be substantially commensurate with an exterior of the body of the apparatus. In this manner, a peripheral profile of the apparatus is substantially consistent between the body and the handle when engaged with the load transfer assembly.

In one embodiment, the first end of the body comprises the first and second leg portions. In one form the first, second leg portions of the body are spaced about the longitudinal axis of the apparatus. In one form, the spacing of the leg portions about the longitudinal axis of the apparatus is equal such that each are in opposite relation with one another.

In one embodiment, each of the first and second leg portions of the body comprise respective apertures. In one form, the respective apertures of the body are configured so as to be substantially concentric one another. In one embodiment, the respective apertures of the body are operable for receiving a first retaining device (such as for example, a retaining pin) so as to allow the load transfer assembly to releasably connect to a pad eye via, for example, an eyelet or aperture of the pad eye. The retaining device could comprise more than one operable component.

In one embodiment, the load transfer assembly comprises componentry which operates at or near the first end of the body. In one form, such componentry is configured so as to establish a releasable connection to the pad eye.

In one embodiment, the load transfer assembly comprises an engager (for example, provided in the form of a clevis) is provided substantially at or near the first end of the body. In one form, the engager comprises first and second leg portions at or near an end thereof. Each first and second leg portion of the engager comprises a respective aperture, each of which are arranged substantially concentric with one another.

In one embodiment, the first and second leg portions of the body are configured so as to substantially correspond with the first and second leg portions of the engager of the load transfer assembly.

In one embodiment, the respective apertures of the first, second leg portions of the body are configured so as to correspond with the respective apertures of the engager of the load transfer assembly such that the first retaining device can be threaded or passed/inserted through the apertures during connection of the load transfer assembly to the pad eye.

In one embodiment, prior to the apparatus being used, the first retaining device is threaded or passed/inserted through:
(i) the respective apertures of the first, second leg portions of the engager,
(ii) the respective apertures of the first, second leg portions of the body, and
(iii) an eyelet or aperture of the pad eye.

In one embodiment, with the first retaining device so threaded or passed/inserted through the apertures as per the above, it is associated with a bush (such as for example, by way of a threaded engagement), which is itself insertable into one of the respective apertures of the first, second leg portions of the engager. In one form, the bush comprises first and second portions whereby the first bush portion is dimensioned (for example, having a smaller diameter) smaller than that of the second bush portion, the smaller sized first bush portion being sized so that the first bush portion is able to pass through either of the apertures of the first, second leg portions of the engager, and the larger sized second bush portion sized so as to abut against a portion/region of a periphery of one of said respective apertures thereby preventing the bush from passing through the relevant aperture when the first retaining device and the bush are engaged.

In one embodiment, one of the first, second leg portions of the engager is configured so as to be operable with a second retaining device. In one form, a channel or bore is formed in at least one of the first, second leg portions of the engager, whereby the channel serves to provide entry and guidance for a spring plunger, the spring plunger having a portion operable for engaging a groove or recessed formation formed on the surface of the first retaining pin or device.

In one embodiment the load transfer assembly comprises a rod member operable with the engager.

In one embodiment, a portion of the rod member is threaded along a shaft portion thereof.

In one embodiment, the engager is configured so that its first, second leg portions meet so as to form a substantially U-shaped form. In one form, at the meeting region of the first, second leg portions is an aperture through which the shaft portion of the rod member may pass. In such embodiments, the aperture of the engager is concentric about the longitudinal axis of the apparatus.

In one embodiment, the rod member comprises a head portion at an end thereof, the head portion being dimensioned or sized larger than the shaft portion. The sizing of the head portion serves to provide an interference engagement with the engager when the shaft portion of the rod member is threaded through the aperture of the engager.

In one embodiment, the load transfer assembly further comprises an insert member assembled between, and substantially concentric with, portions of the rod member and the body. In one form, the insert member is of tubular form. In one arrangement, the rod member passes through an interior bore region of the insert member. In one embodiment, a portion of a wall of the insert member serves to define, in part, the chamber. In one embodiment, a portion of an exterior facing wall of the insert member serves to define, in part, the chamber.

In one embodiment, the load transfer assembly comprises a piston. In one form, the piston is operable with the rod member.

In one embodiment, the piston comprises a base portion, a head portion extending from the base portion, and an interior bore region extending through the piston through which the rod member passes so as to associate with the piston. In one embodiment, the bore of the piston is substantially concentric with the longitudinal axis of the apparatus.

In one form, the association between the piston and the rod member is by way of a threaded engagement. In this manner, said association between the piston and the rod member allows for the rod member freedom to rotate about the longitudinal axis of the apparatus relative to the piston but restricts or constrains movement of the rod member relative to the piston along the longitudinal axis of the apparatus. As such, while rotation of the rod member is provided (so as to allow the relative positioning of the rod member and piston to be modified as may be needed) both components are in fixed relation with each when either moves (or translates) along the longitudinal axis of the apparatus (ie. rotation of the rod member while the piston is stationary allows the rod member to translate along the longitudinal axis independent of the piston, but when both the rod member and the piston are in fixed relation with each other, movement of either along the longitudinal axis will cause both to translate there along together).

In one embodiment, the piston is operable with the chamber such that fluid accommodated in the chamber, when under pressure, facilitates or encourages movement of the piston along the longitudinal axis of the apparatus.

In one embodiment, the body comprises one or more recesses formed in an interior wall of the bore of the body, which interior wall resides adjacent respective portions of the exterior facing wall of the insert member. In one embodiment, one of the one or more recesses is used to support or accommodate a retaining device used to prevent the insert member from falling out of position relative to the body. For example, such a retaining device may be provided in the form of a circlip.

In one embodiment, the insert member, when the rod member is threaded in its interior bore region, allows movement of the rod member along the longitudinal axis of the apparatus.

In one embodiment, the insert member operates, in part, so as to prevent leakage of fluid (which enters the chamber via a fluid injection port) from the chamber on movement of the piston by way of one or more sealing assemblies provided between facing surfaces of the insert member and portion/region of the bore of the body. In this regard, a fluid seal is established between the bore of the body and the insert member. Such sealing assemblies may comprise one or more sealing elements. In one embodiment, such sealing assemblies may comprise one or more of: an insert ‘O’-ring, and/or a seal ring.

In one embodiment, an interior portion of the bore of the body provides a seat on which the base portion of the piston sits when the apparatus is in a non-pressurised or initial condition.

In one embodiment, one or more seals may be provided between the exterior surface of the insert member and an interior wall of the bore of the base portion of the piston.

In one embodiment, an end of the body is closed by way of a closure, the closure being releasably engageable with a portion/region of said end of the body (by way of, for example, corresponding and respective threaded portions/regions. In this regard, a threaded region is provided on a region of a wall of the bore at or near the said end of the body which threadedly engages with a corresponding thread provided on a region of an exterior surface of the closure. In this manner, the closure can be releasably engageable with the body in a substantially concentric manner.

In one embodiment, the closure comprises a bore extending therethrough and which is substantially concentric with the longitudinal axis of the apparatus. In one form, a sealing element (such as for example, a wiper seal) is provided between an exterior surface of the head portion of the piston and a portion of an interior wall of the bore of the closure, thereby establishing a fluid seal between the piston and the closure.

In another embodiment, a sealing element is provided between a portion/region of a wall of the bore of the body and the exterior surface of the base portion of the piston, thereby establishing a fluid seal between the body and the piston.

In one embodiment, a fluidly sealed cylindrical region in which the base portion of the piston operates is defined by a wall portion of the bore of the body, a wall portion of the closure, a portion of the seat of the body, and a wall portion of the insert member.

In one embodiment, the chamber is defined by the seat of the body, a lower facing surface of the base portion of the piston, and a wall portion of the insert member. Accordingly, portions of the body operate to define both the cylinder region and the chamber, advantages being the ability to provide an integrated pressurisable fluid chamber for use in developing a load of sufficient magnitude to load test pad eye and like items.

In one embodiment, a free end of the rod member is accommodated in a recess provided in an internal region of the handle. In one arrangement, the recess is formed in an interior facing surface of the handle. In one embodiment, the recess if of circular form and substantially concentric with the longitudinal axis of the apparatus.

In one embodiment, the rod member comprises an aperture provided at or near said free end of the rod member. In one arrangement, said aperture is sized so as to be capable of receiving a retaining device, such as for example a retaining pin.

In one embodiment, the handle is configured so that an aperture passes through the recess, said aperture being engineered (formed and sized) so as to receive the retaining device/pin adjacent an externally facing side of the handle. In one embodiment, the aperture provided at the free end of the rod member and the aperture formed within the handle and passing through the recess of the handle, are substantially concentric one another when the free end of the rod member is inserted within the recess of the handle, the concentric relationship allowing the retaining pin to register and be threaded through the apertures so as to connect or key the rod member to the handle. In this manner, rotation of the handle (via a gripping portion operable by a user serves to also rotate the rod member—as the rod member has rotational freedom about the longitudinal axis of the body/apparatus. As, in one embodiment, the rod member is threadedly engaged with the piston, rotation of the rod member by way of the handle translates or moves/translates the rod member with respect to the body along the longitudinal axis of the apparatus. In this manner, the (initial or otherwise) position of the rod member, and consequently the engager, can be varied/adjusted as needed (generally depending on the geometry of the pad eye to be subject to testing).

In one embodiment, fluid (eg. a non-compressible fluid) enters the chamber by way of a fluid injection port. In operation, fluid pressurised in the chamber acts against a surface of the piston (such as for example, a surface of the base portion of the piston adjacent the seat of the body) in a manner that facilitates or encourages movement of the piston. A compressible fluid, such as for example air, could be used for operation of embodiments of the apparatus. However, a pneumatic configuration has the potential to reduce the usefulness of the apparatus in that a longer period of time (as compared using a non-compressible fluid) may be needed in order for the appropriate pressure to be built up for testing purposes.

In one embodiment, the arrangement of the load transfer assembly and the body is adjustable so that the apparatus can be used to lift points/pad-eyes of different geometries. In this regard, apertures of respective first, second portions of the body are dimensioned so that the retaining pin (and the engager) can be threaded or passed through an aperture of the pad eye that may be spaced at varying distances from the surface of the host object (to which the relevant lift point/pad-eye is connected to). Differing geometries of this type may be accommodated by threading the rod member with the piston further along the shaft portion of the rod member as appropriate (by way of its connection or keying to the handle). Therefore, different spacings of the eyelet or aperture of the pad eye can be accommodated by the user of the apparatus simply rotating the handle thereby translating the rod member along the longitudinal axis of the apparatus until the apertures of the engager are substantially concentric with the eyelet/aperture of the relevant pad eye, following which the retaining pin can be inserted (and secured).

In operation of at least one embodiment, the apparatus is placed adjacent a pad eye to be tested. In this regard, the apparatus is positioned such that the first, second leg portions of the body, and the first, second leg portions of the engager are substantially concentric with an aperture or eyelet of the pad eye.

The load transfer assembly is then adjusted/modified so that the first retaining device can be threaded through the respective apertures of both the first, second leg portions of the body and the engager, and the aperture/eyelet of the pad eye.

As noted above, such adjusted may require the manual manipulation of the handle so as to translate the rod member (and consequently the engager) along the longitudinal axis of the apparatus so that the respective apertures of the first, second leg portions of the body and the engager, and the aperture/eyelet of the pad eye are substantially concentric with one another.

A fluid source is then connected to the fluid injection port, and a flow of fluid encouraged into the chamber. As the only freedom of movement of the piston is, along the longitudinal axis of the apparatus, increases in fluid pressure, serve to encourage further movement of the piston which, in turn, due the piston's threaded engagement with the rod member, facilitates movement of the rod member in the same direction. As the engager is connected to the relevant pad eye, and the body supported (at the first end thereof) on the surface of the host object, relative movement of the rod member (relative to the body and the host object) will commence. However, such movement will be resisted by the connection between the pad eye which will result in a load being applied to the pad eye and consequently the connection. As such, increased fluid pressure is needed to increase the force applied to the pad eye, and consequently its connection to the host object.

An operator of embodiments of the apparatus will continue to increase the fluid pressure until a designated load (that required by the applicable regulatory framework) is reached, or the connection or the pad eye itself fails.

According to a second principal aspect, there is provided a method for load testing a connection point associated with an object, the method comprising:
providing any embodiment of an apparatus as described herein,
locating the apparatus on a surface of the object so as to be substantially concentric with the connection point,
connecting the connection point to the apparatus,
operating the apparatus so as to generate a force for transfer to the connection point.

According to a third principal aspect, there is provided a method for testing the strength of an association of a connection point (or similar) to an object, the method comprising:
providing an apparatus comprising:
   a body, the body having a surface configured for placement against a surface of the object so that force applied by the body to the surface of the object can be reacted against during operation of the apparatus,
   a load transfer assembly operable within a profile of the body, and releasably connectable to the connection point associated with the object, the load transfer assembly configured operable with the body for generating a force for transfer to the connection point for testing its association to the object,
   the body configured so that a portion thereof, cooperatively with the load transfer assembly, defines a chamber internal of the body for accommodating a fluid which, when placed under pressure, renders the load transfer assembly operable,
locating the apparatus on a surface of the object so as to be substantially concentric with the connection point,
connecting the connection point to the load transfer assembly of the apparatus,
delivering fluid to the chamber so as operate the load transfer assembly.

According to a fourth principal aspect, there is provided a connection point test apparatus for testing the strength of an association of a connection point (or similar) to an object, the connection point test apparatus comprising:
a body of substantially unitary form, the body having a surface configured for placement against a surface of the object so that force applied by the body to the surface of the object can be reacted against during operation of the apparatus,
a load transfer assembly operable within a profile of the body, and releasably connectable to the connection point associated with the object, the load transfer assembly configured operable with the body for generating a force for transfer to the connection point for testing its association to the object,
the body configured so that a portion thereof, cooperatively with the load transfer assembly, defines a chamber internal of the body for accommodating a fluid which, when placed under pressure, renders the load transfer assembly operable.

In one embodiment, the body is of cylindrical or tubular form concentric with a longitudinal axis of the connection point test apparatus, the body having a bore extending therethrough defining a periphery of the bore within which the load transfer assembly operates.

In one embodiment, the bore is configured having a narrowing portion at a region along the longitudinal axis for defining first and second portions of the bore either side of the narrowing portion, the first portion of the bore configured for providing the portion of the body which cooperates with a portion of the load transfer assembly for defining the chamber, the second portion of the bore configured for providing a region of space in which a portion of the load transfer assembly connects with the connection point.

In one embodiment, the surface of the body configured for placement against the surface of the object is provided at an end region of the body in the form of first and second spaced apart and substantially opposing leg portions.

In one embodiment, each of the first and second leg portions at said end region of the body comprise respective apertures arranged substantially concentric one another, each aperture configured for receiving a retaining device operable for use in connecting the load transfer assembly with the connection point.

In one embodiment, the load transfer assembly comprises an engager provided operable substantially within the region of space provided by the second portion of the bore of the body, the engager comprising first and second leg portions each comprising respective apertures arranged substantially concentric with one another.

In one embodiment, respective apertures of the first, second leg portions at said end region of the body substantially correspond with or are substantially concentric with respective apertures of the engager so that the retaining device can be passed through all said apertures in connecting of the load transfer assembly with the connection point.

In one embodiment, the connection point test apparatus further comprising a bush member operable with the retaining device and adjacently disposed apertures of the leg portions of the engager and at said end region of the body for maintaining a desired alignment of the engager relative to the body.

In one embodiment, the load transfer assembly comprises a rod member operable with the engager such that movement of the rod member in a direction along the longitudinal axis of the connection point test apparatus causes movement of the engager in at least said direction.

In one embodiment, the load transfer assembly comprises a piston operable with the rod member, the piston comprising a bore extending through the piston and through which the rod member passes so as to associate with the piston by way of a threaded engagement, such threaded engagement allowing:
(i) the rod member freedom to rotate relative to the piston about the longitudinal axis of the connection point test apparatus so that the rod member can translate along the longitudinal axis independent of the piston, while
(ii) providing for movement of the rod member and the piston together along the longitudinal axis when either are in fixed relation with the other when either are caused to be moved along the longitudinal axis.

In one embodiment, the piston is operable with the chamber such that fluid accommodated in the chamber, when under pressure, facilitates or encourages movement of the piston along the longitudinal axis of the connection point test apparatus.

In one embodiment, the chamber is defined by at least a portion of the narrowing portion of the bore of the body defining the first bore portion, and a portion of the piston that faces said portion of said narrowing portion.

In one embodiment, the load transfer assembly is configured operable with a handle for use in facilitating translation of the rod member of the load transfer assembly along the longitudinal axis for aligning the apertures of the engager and those at said end region of the body with an aperture provided by the connection point for allowing insertion of the retaining device for connecting the load transfer assembly with the connection point.

In one embodiment, the handle is configured of a tubular form that is substantially commensurate with the profile of the body when the handle is arranged operable with the load transfer assembly.

In one embodiment, the handle is engageable with the rod member so that both the rod member and the handle can be provided in fixed relation with each other thereby allowing for rotation of the rod member via the handle.

In one embodiment, the chamber is provided in fluid communication with a fluid injection port operable for allowing fluid to be selectively introduced into the chamber for operation of the connection point test apparatus.

In one embodiment, the body is formed so as to be of a single piece.

In one embodiment, the body is assembled from more than one separate pieces, the assembly of which provides the substantially unitary form of the body.

In one embodiment, the body is assembled from first and second separate pieces, the first separate piece configured so as to provide the portion of the body which cooperatively defines the chamber with the load transfer assembly, and the second separate piece configured so as to provide the surface of the body configured for placement against the surface of the object.

Embodiments of the fourth principal aspect may comprise or incorporate any of the features described in relation to the first principal aspect, or as described herein.

According to a fifth principal aspect, there is provided a method for testing the strength of an association of a connection point (or similar) to an object, the method comprising:
providing an apparatus comprising:
   a body of substantially unitary form, the body having a surface configured for placement against a surface of the object so that force applied by the body to the surface of the object can be reacted against during operation of the apparatus,
   a load transfer assembly operable within a profile of the body, and releasably connectable to the connection point associated with the object, the load transfer assembly configured operable with the body for generating a force for transfer to the connection point for testing its association to the object,
   the body configured so that a portion thereof, cooperatively with the load transfer assembly, defines a chamber internal of the body for accommodating a fluid which, when placed under pressure, renders the load transfer assembly operable,
locating the apparatus on a surface of the object so as to be substantially concentric with the connection point,
connecting the connection point to the load transfer assembly of the apparatus,
delivering fluid to the chamber so as operate the load transfer assembly.

Embodiments of the fifth principal aspect may comprise or incorporate any of the features described in relation to the first or fourth principal aspects, or as described herein.

According to another principal aspect, there is provided a method of using any embodiment of an apparatus as described or claimed herein for the purpose of load testing any of the following: a connection point, a coupling point, a lift or lifting point, a restraint associated with an object, a pad eye.

According to another principal aspect, there is provided a method of operably configuring a connection point (new or otherwise) load testing apparatus so as to exemplify substantially any embodiment of the apparatus described herein.

According to a further principal aspect, there is provided a kit of parts comprising any of the features described herein, in any combination.

Various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### BRIEF DESCRIPTION OF THE DRAWINGS

Further features of the inventive principles are more fully described in the following description of several non-limiting embodiments thereof. This description is included solely for the purposes of exemplifying the inventive principles. It should not be understood as a restriction on the broad summary, disclosure or description as set out above. The description will be made with reference to the accompanying drawings in which:

FIG. 1 shows a perspective view of one embodiment of an apparatus arranged in accordance with the principles described herein;

FIG. 2 shows a further perspective view of the embodiment described in FIG. 1 (but with the handle and clevis pin rotated slightly);

FIG. 3 shows a further perspective view (looking from the lower portion) of the embodiment shown in FIGS. 1 and 2;

FIG. 4 shows an exploded perspective view of the embodiment shown in FIGS. 1 to 3;

FIG. 5 shows a perspective view of the body of the apparatus shown in FIG. 1;

FIG. 6 shows a perspective view of the embodiment shown in FIGS. 1 to 4, with the cylinder body removed;

FIG. 7 shows a perspective view of the embodiment shown in FIGS. 1 to 4, with the cylinder and handle removed;

FIG. 8 shows a perspective view of the embodiment shown in FIGS. 1 to 4, with the handle removed;

FIG. 9A shows a cross section view of the embodiment shown in the preceding Figures, with the alignment shown in FIG. 2, and identifies regions A and B shown in FIGS. 9B and 9C respectively;

FIG. 9B shows a cross section view of region A identified in FIG. 9A;

FIG. 9C shows a cross section view of region B identified in FIG. 9A;

FIG. 10 shows a perspective view of the cross section shown in FIGS. 9A-9C;

FIG. 11 shows a cross section view of another embodiment of an apparatus arranged in accordance with the principles described herein;

FIG. 12 shows a cross section view of a further embodiment of an apparatus arranged in accordance with the principles described herein, whereby the body is defined by two portions coupled or connected together at an interface region; and

FIG. 13 shows a cross section view of the embodiment shown in FIG. 11, showing operation of the apparatus when testing a connection point.

In the figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted in order to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the particular arrangements of the embodiment(s) as well as of the particular applications of such embodiment(s).

Specifically, reference to positional descriptions, such as ‘lower’ and ‘upper’, and associated forms such as ‘uppermost’ and ‘lowermost’, are to be taken in context of the embodiments shown in the figures, and are not to be taken as limiting the scope of the principles described herein to the literal interpretation of the term, but rather as would be understood by the skilled reader.

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION

The words used in the specification are words of description rather than limitation, and it is to be understood that various changes may be made without departing from the spirit and scope of any aspect of the invention. Those skilled in the art will readily appreciate that a wide variety of modifications, variations, alterations, and combinations can be made with respect to the above described embodiments without departing from the spirit and scope of any aspect of the invention, and that such modifications, variations, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

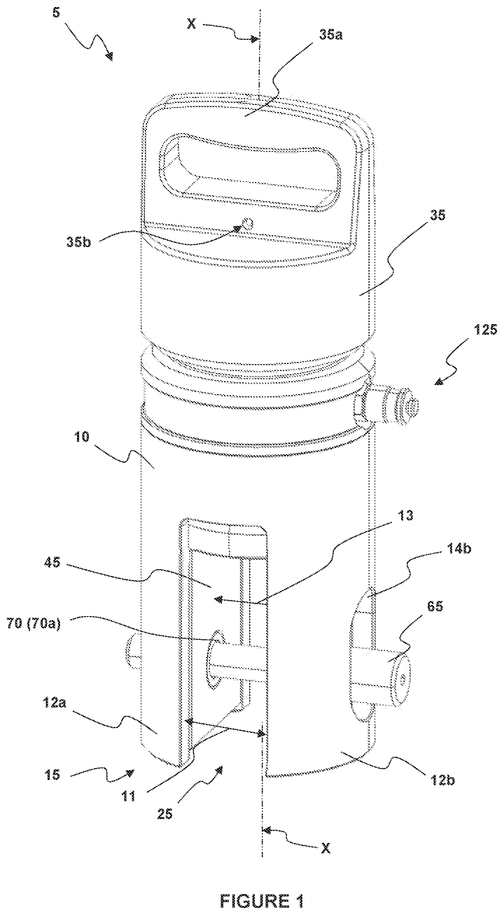

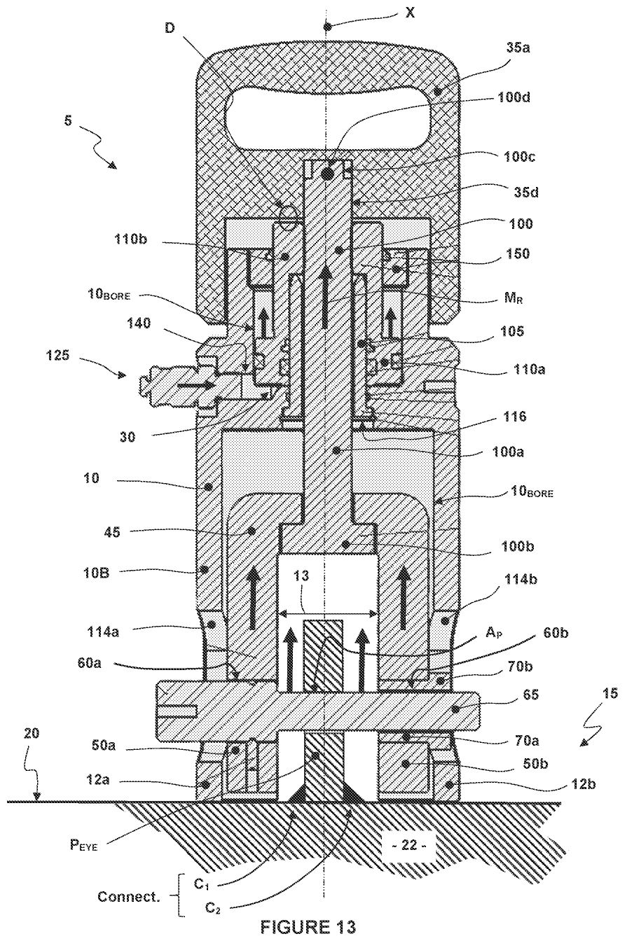

FIG. 1 shows one embodiment of a connection point test apparatus (hereinafter, apparatus 5) arranged in accordance with the principles described herein for use in the load testing of a connection point, such as for example, testing the structural capacity of a connection between the connection point and a heavy/large mass host body/object that is to be handled (generally, by way of lifting activities). As such items are generally used to operate as attachment points to connect lifting equipment (such as lifting ropes/wires) so as to lift/move the host body/object, a level of confidence is needed to provide an operator (and indeed, any of the underwriters/stake holders of the equipment/object(s) involved in the handling procedure(s)) a level of assurance that the connection is capable of sustaining the lifting load during lifting/handling. Accordingly, a connection point in the context of the description herein comprises, non-exhaustively, a point used for the purpose of serving as, in part, a point of attachment/coupling for handling large heavy objects using, such as for example, specific handling machinery. Such connection points may comprise, for example: attachment points, coupling points, lifting points, restraints formed with or coupled to attachment points, and pad-eyes. The skilled reader would readily appreciate the types of equipment that could be used for the purposes of providing such a connection point when handling heavy objects, equipment, structures, machinery and the like. Accordingly, for the remainder of this description, all applicable and relevant items are referred to as a pad eye P_{EYE} whereby description of the apparatus 5 and its operation is via connection to the surface 20 of a host body 22 by way of weld connections C₁, C₂, as shown in FIG. 13.

The apparatus 5 comprises a body 10 is configured operable so as to provide a surface at an end 15 for allowing the body to abut against a surface 20 of an object 22 (shown in FIG. 13) to which the pad-eye P_{EYE} is connected to (generally by way of appropriate welding process(es)/technique(s) and the like). In this manner, placement of the end 15 of the apparatus 5 against the surface 20 of the object 22 is so that force applied by the body 10 to the surface 20 can be reacted against during operation of the apparatus 5.

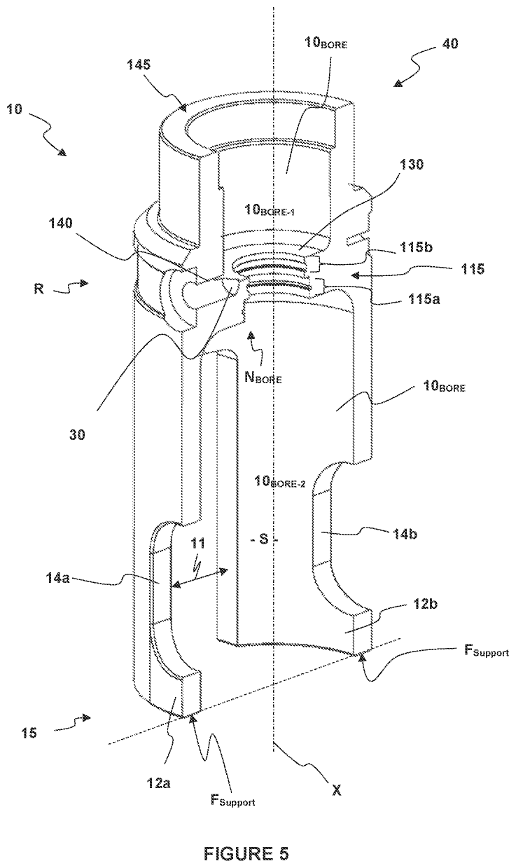

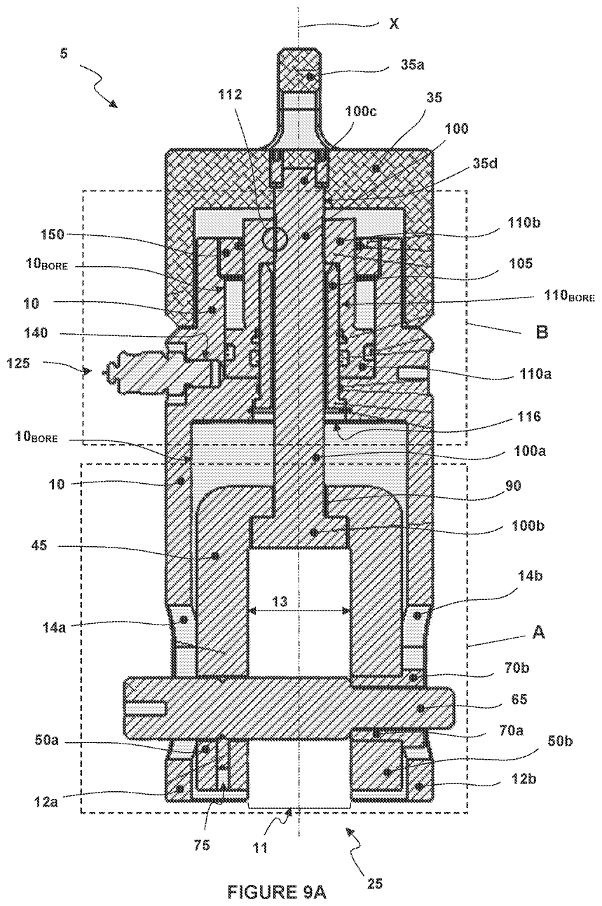

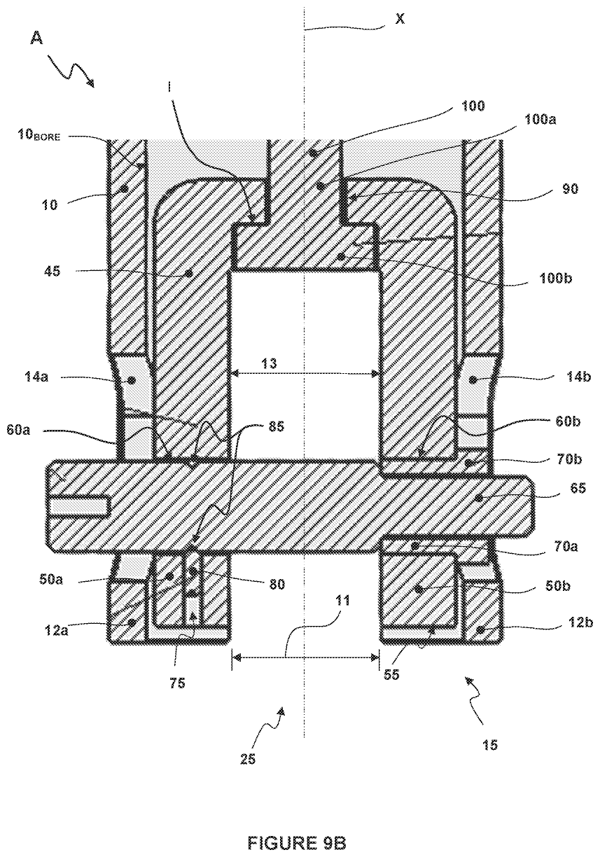

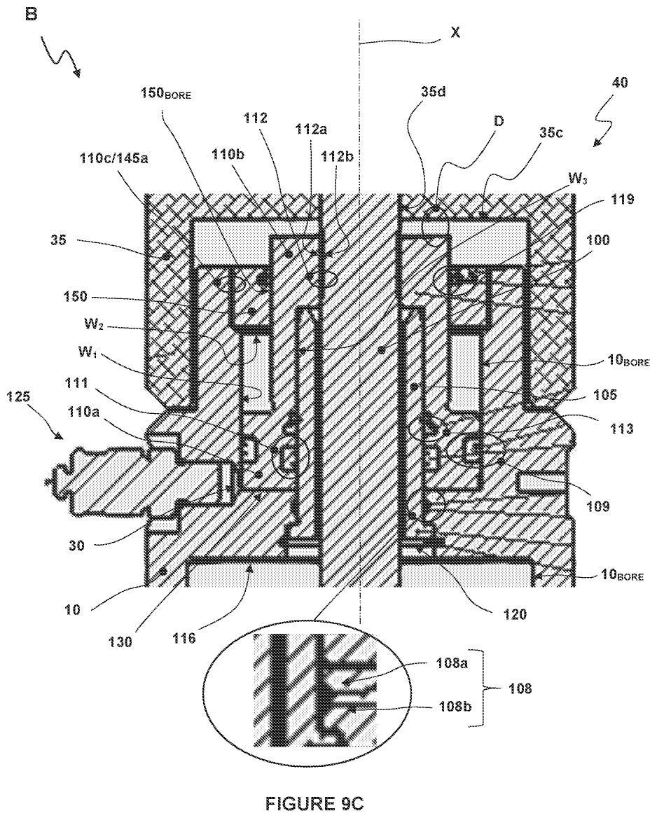

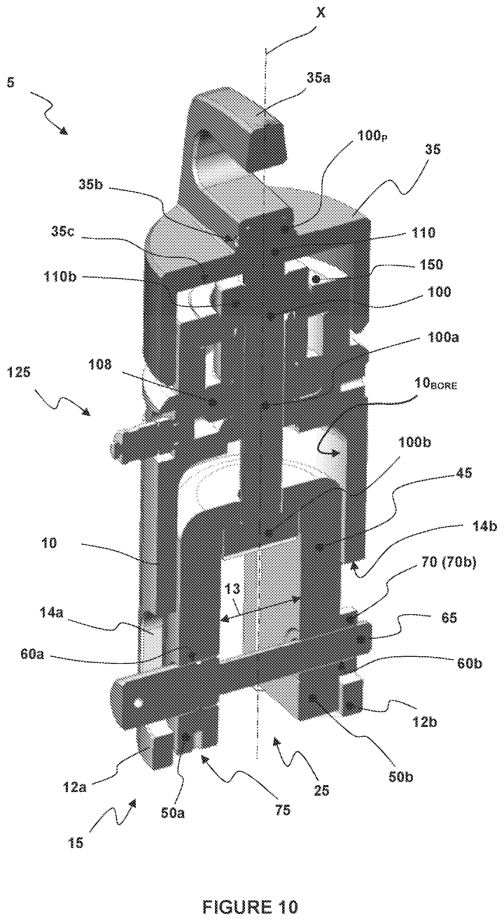

The body 10 comprises a bore 10_{BORE} of varying cross section shape (refer FIG. 5, and FIGS. 9 to 13) extending therethrough as shown in the Figures. The bore 10_{BORE} defines a periphery (eg. interior wall of the bore) within which the load transfer assembly 25 operates.

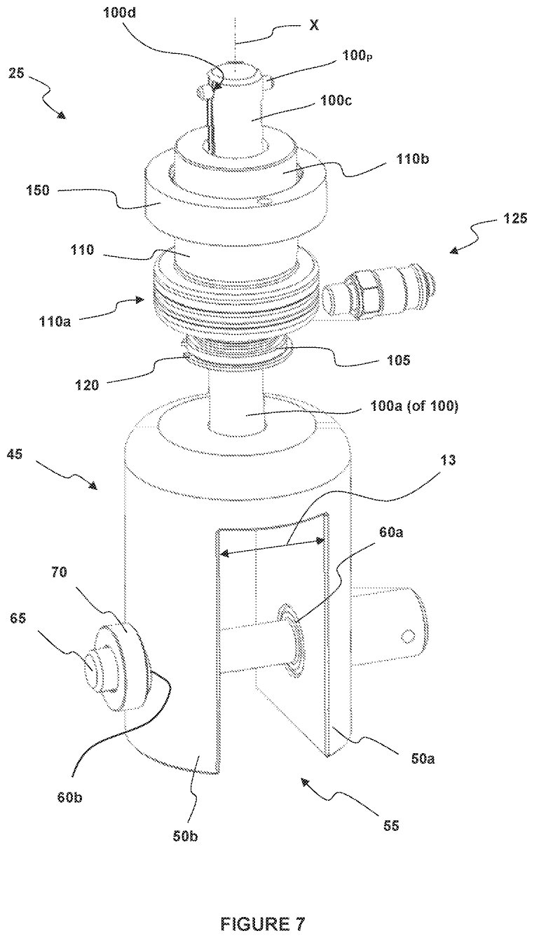

The apparatus 5 further comprises a load transfer assembly 25 (shown in FIG. 7) operably associated with the body 10, and releasably connectable to the pad-eye P_{EYE}. The load transfer assembly 25 is configured operable with the body 10 for generating a force for transfer to the pad eye P_{EYE} for testing its connection (via connections C₁, C₂) to the (host) object 22. The body 10 is configured so that a portion thereof, cooperatively with the load transfer assembly 25, defines a chamber 30 internal of the body (see FIGS. 9 to 13) for accommodating a fluid (such as for example, a non-compressible fluid) which, when placed under pressure, renders the load transfer assembly 25 operable. As noted, application of the load developed by the load transfer assembly 25 is for the purpose of testing the strength/integrity of the connection of the pad-eye P_{EYE} to the object 22. With reference to FIG. 5, the bore 10_{BORE} is configured having a narrowing portion N_{BORE} at a region R along the longitudinal axis X for defining first 10_{BORE-1} and second 10_{BORE-2} portions of the bore 10_{BORE} either side of the narrowing portion N_{BORE}. The first portion 10_{BORE-1} of the bore 10_{BORE} is configured for providing the portion of the body 10 which cooperates with a portion, or portion of a constituent component, of the load transfer assembly 25 for defining the chamber 30. The second portion 10_{BORE-2} of the bore 10_{BORE} is configured for providing a region of space S in which a portion of the load transfer assembly 25 connects with the connection point (C₁, C₂).

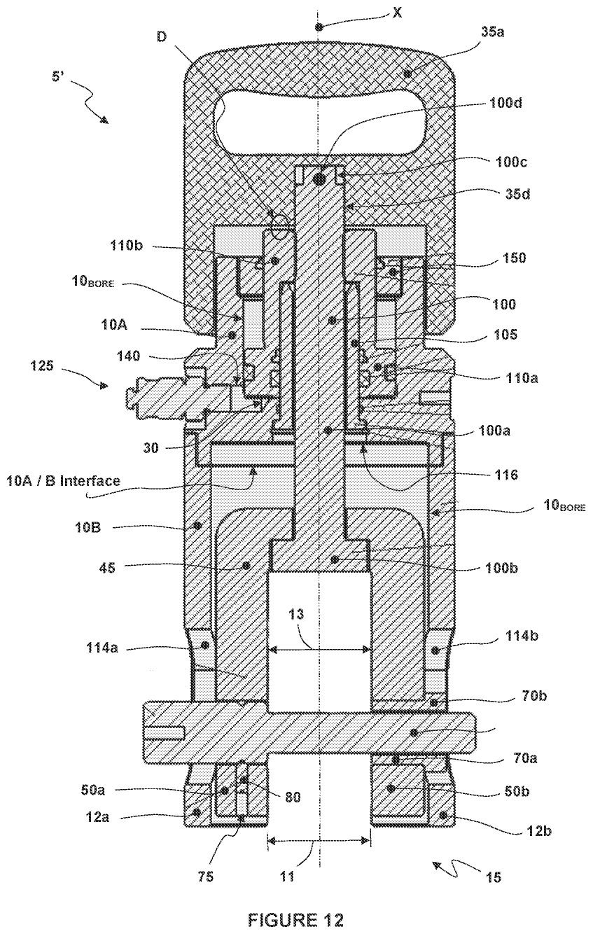

As shown in the Figures, the body 10 is provided of a generally unitary form which serves to provide, in at least one aspect, an integrated environment for all components (eg. the load transfer assembly 25) to operate within. However, in other embodiments (as will be described below with reference to FIG. 12), the unitary form of the body 10 can be defined or provided by more than one separate portion (two separate portions in the embodiment shown in FIG. 12), with each separate portion being configured so that when assembled together they operate to provide a generally integrated body capable of operating in accordance with the principles described herein. The integrated nature of the body 10 assists in allowing the apparatus 5 to exemplify a reduced profile as compared existing pad-eye testing equipment. In this manner, with the chamber 30 being, in part, defined by internal portions of the body 10, operational reliance of the apparatus 5 is not placed on the use of third party hydraulic (or in some cases, pneumatic) ram arrangements. Thus, such integration of the chamber 30 within the body 10 of the apparatus 5 allows the apparatus to confer advantage in weight (for example, allowing ease of handling, human/user ergonomics), space (for example, allowing convenience in packaging, storage), and/or cost (less expense required for purchasing off the shelf hydraulic components). Furthermore, with a reduced overall profile, and with the load bearing components operating internal of the body 10, embodiments of the apparatus 5 can be used to safely test pad eyes that may be difficult to access using conventional load testing equipment.

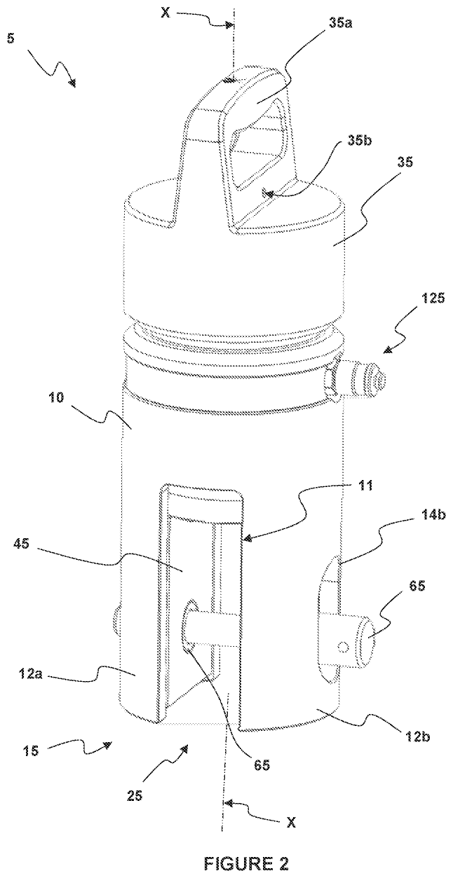

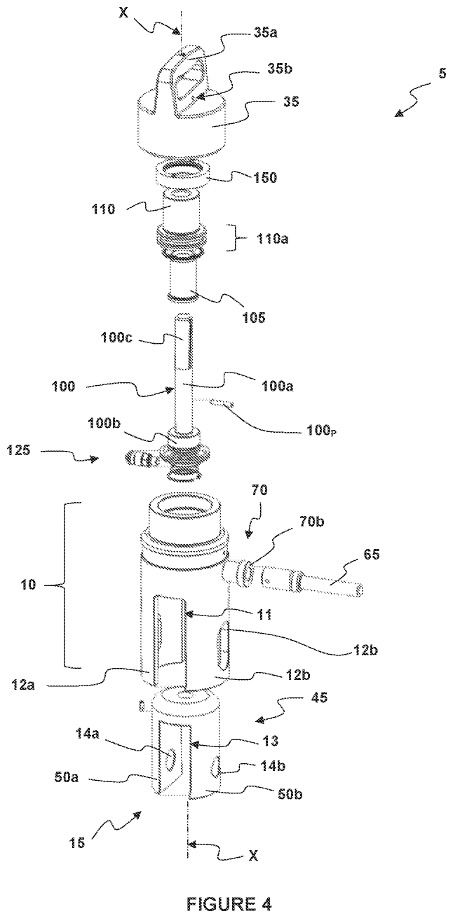

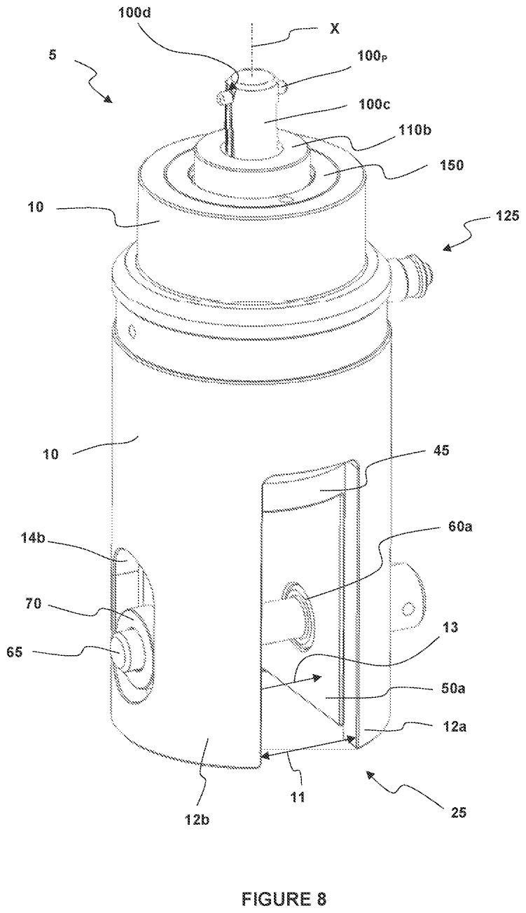

As shown in the FIGS. 1 to 8, the apparatus 5 comprises a handle portion 35 configured so as to allow the apparatus to be carried by way of a gripping portion 35a. In this manner, the apparatus 5 can be readily portable, as well as easily handled by an operator when placing the apparatus in a position for load testing purposes (such as for example, at locations/regions which could be difficult to access for testing purposes when using existing equipment). As can be seen in the Figures, the apparatus 5 has a generally small/slender profile which assists in allowing the apparatus to be operable in difficult areas/spaces. The handle 35 is configured of a tubular form that is substantially commensurate with the profile of the body 10 when the handle 35 is arranged operable with the load transfer assembly 25. As shown in the Figures, the periphery of the handle 35 defined by its tubular form is of a profile that is substantially similar to that of a substantial portion of the body 10.

With reference to FIG. 5 (which shows a perspective view of the cross-section of the body 10 isolated from the remainder of the components), the body 10 is of cylindrical/tubular form and formed concentric about a longitudinal axis X of the apparatus 5. As shown, the body 10 comprises ends 15 (lowermost end, for the orientation shown) and 40 (uppermost end, for the orientation shown). As noted, end 15 is configured with a generally uniform or flat face F (facing downward in FIG. 15) so as to abut against the surface 20 of the object 22 during use (as shown in FIG. 13). End 40 of the body 10 is configured so as to operate with various of the main loading generating componentry of the load transfer assembly 25, as will described below.

End 15 of the body 10 comprises spaced apart opposing leg portions 12a, 12b (which form a spaced slot region 11 as shown in the Figures) each of which comprise respective apertures 14a, 14b. As will be described below, apertures 14a, 14b are operable for receiving a pin 65 (see at least FIG. 1) so as to allow the load transfer assembly 25 to releasably connect to the pad-eye P_{EYE}.

The load transfer assembly 25 comprises componentry proximal with end 15 of the body 10, which are configured so as to establish a releasable connection to the pad-eye P_{EYE}. As the skilled reader would readily understand, the general form of a pad-eye P_{EYE} (being simply a plate or similar with an aperture (A_{P}) (as indicated in FIG. 13), eyelet, opening, or loop formed therethrough) confers a point of attachment to a mass of sufficient weight/geometry where lifting equipment is needed for handling purposes. In the general sense, placement of a pad-eye P_{EYE} to such a mass (22) allows a shackle (having a generally U-shaped body whereby the open region provided by its free ends can be closed by a pin (threaded, or lockable using other configurations) or similar) or similar load bearing component to be releasably connectable to the pad-eye. A rope or wire cable of sufficient structural strength can then be connected to the shackle, allowing the mass (22) to be lifted/handled as appropriate.

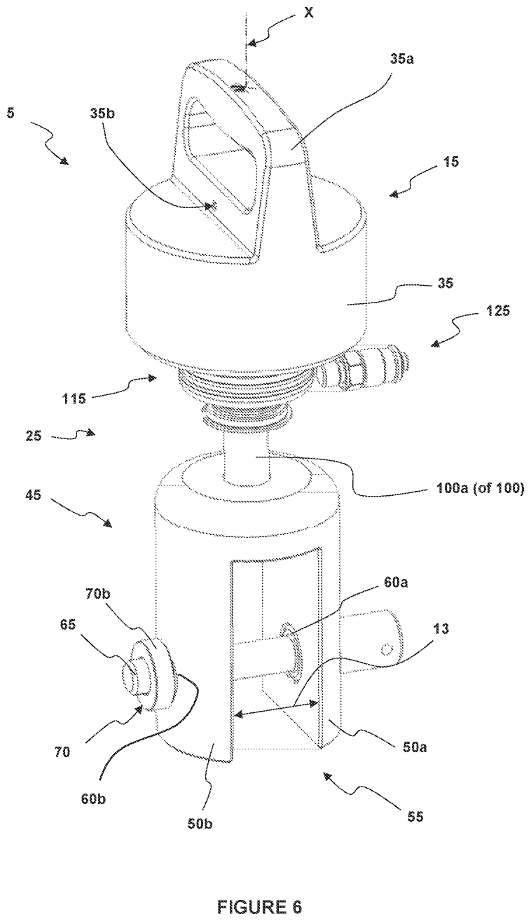

The load transfer assembly 25 comprises an engager provided in the form of a clevis 45 provided substantially adjacent end 15 of the body 10, the engager serving to connect (in a releasable manner) with a target pad eye. As shown in FIG. 6 (which shows a perspective view showing the load transfer assembly 25 with the body 10 removed), the clevis 45 comprises spaced apart leg portions 50a, 50b (which form a spaced slot region 13 as shown in the Figures) at its distal end 55. Each leg portion 50a, 50b of the clevis 45 comprise respective apertures 60a, 60b, each of which are arranged substantially concentric with one another so as to be capable of receiving the clevis pin 65. The apertures 60a, 60b of the clevis 45 correspond substantially with the apertures 14a, 14b of the body 10, however, as will be clear from the figures, the sizing is different for adjustment purposes. For example, the size of the apertures 60a, 60b is smaller than the size of the apertures 14a, 14b so that the load transfer assembly 25 can be adjusted (ie. translated along the longitudinal axis X) relative to the body 10 to account for pad eyes of varying geometry. Furthermore, in some embodiments, the clevis pin 65 may be formed in various sizes to suit different sizes of apertures/eyelets of respective pad-eyes P_{EYE} so that the apparatus 5 may be used to load test different types of pad-eyes P_{EYE}. Thus, the geometry of the clevis pin 65 can be formed or configured of variable sizes/dimensions in length and/or diameter to fit or be operable with a variety of sizes of pad-eye apertures/eyelets/loops. In some embodiments, the length of the clevis pin 65 may be substantially equal to or less than the outer diameter of the body 10 of the apparatus 5. The clevis pin 65 may be configured so as to comprise, or be operable with, one or more parts/components which operate to prevent the clevis pin 65 from slipping from position after being received by at least the apertures 60a, 60b.

Prior to the apparatus 5 being used (to apply the required load), the clevis pin 65 is threaded (ie. passed/inserted) through:
(i) apertures 60a, 60b of the clevis 45,
(ii) apertures 14a, 14b of the leg portions 12a, 12b of the body 10, and
(iii) the aperture Ap of the pad-eye P_{EYE} (see FIG. 13).

With reference to FIGS. 9A through 9C, once the clevis pin 65 is so threaded (ie. passed/inserted), it is threadedly engaged with a pin bush 70 which is inserted into aperture 60b of leg portion 50b of the clevis 45—the threaded engagement between the clevis pin 65 and the pin bush 70 serving to secure both components in position within the apertures.

The pin bush 70 comprises a bush portion 70a and a head portion 70b. The bush portion 70a is configured having a smaller diameter than that of the head portion 70b, the smaller diameter being sized so that the bush portion 70a is able to pass through the aperture 60b of the clevis 45, and the larger diameter of the head portion 70b sized so that a surface of a stepped region (shown in better detail in FIG. 9B—the stepped portion being the transition from the smaller diameter of the bush portion 70a to the larger diameter of the head portion 70b) which abuts against a portion/region of the periphery of the aperture 60b thereby preventing the pin bush 70 from passing completely through the aperture 60b when the clevis pin 65 and the pin bush 70 are threadedly engaged in the manner shown in FIGS. 9A/9B.

Furthermore, a further purpose of the engagement between the pin bush 70 and the aperture 60b of the clevis 45 is to prevent the clevis from rotating about the longitudinal axis X of the apparatus 5. As such, the pin bush 70 ensures that the clevis 45 remains orientated as desired in line with the slot 11 provided in the body 10. In this manner, the pin bush 70 achieves this by engaging or being guided by the sides of any of apertures 14a, 14b in the body 10.

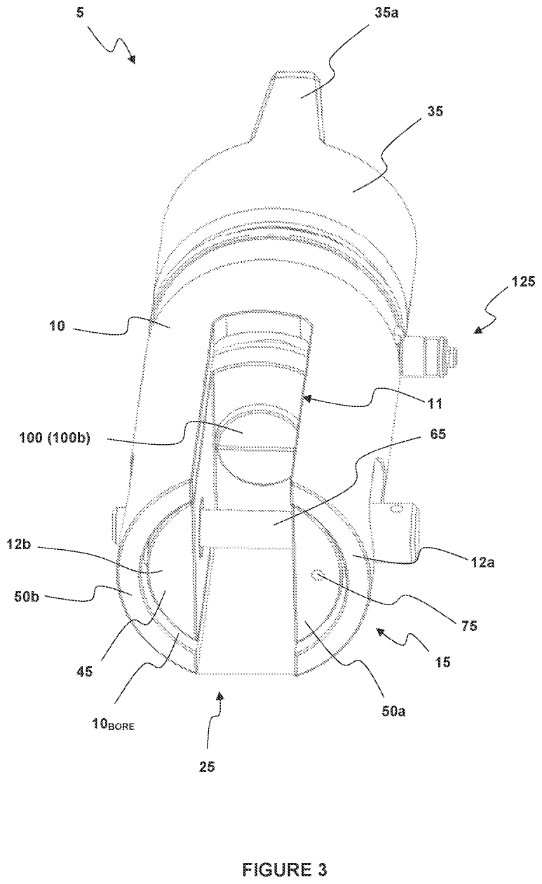

As seen in FIG. 3 and FIGS. 9A, 9B, a channel 75 is formed in the base of leg portion 50a of clevis 45, the channel serving to provide entry and guidance for a spring plunger 80 which engages a grooved or recessed formation 85 formed on the surface of the clevis pin 65 at the location shown. As the skilled reader would appreciate, assembly of the clevis pin 65 with the pin bush 70 and the spring plunger 80 serve to safely secure the clevis pin when capturing the pad-eye P_{EYE} prior to testing.

The skilled reader will appreciate that the above description serves to outline the ability of the load transfer assembly 25, at its end 15, to capture and secure the pad-eye P_{EYE} for testing purposes.

Moving away from end 15, the clevis 45 is configured so that its leg portions 50a and 50b meet, thereby forming a substantially U-shaped form. At the meeting region of the leg portions 50a and 50b is an aperture 90 through which a shaft portion 100a of a threaded rod 100 passes so as to reside in the configuration shown in FIGS. 9A to 9C. The aperture 90, and indeed all components of the load transfer assembly 25, are concentric about the longitudinal axis X of the apparatus 5.

A head portion 100b of the threaded rod 100 is dimensioned larger than the shaft portion 100a such that the head portion abuts against an interior region I peripheral of the aperture 90 of the clevis 45 thereby providing an interference point. It will be appreciated that when in use (ie. the load transfer assembly 25 being connected with the pad-eye P_{EYE}), the interreference between the head portion 100b and the clevis 45 at the interior region I peripheral of the aperture 90 operates to transfer the load from the load transfer assembly 25 to the pad-eye P_{EYE} via the clevis 45 and clevis pin 65 components on translation of the threaded rod 100 upwards along the longitudinal axis X of the apparatus 5.

When assembled as shown in FIGS. 9A, 9B and 9C, the threaded rod 100 extends (upwards in the orientation shown) towards end 40 of the body 10. In doing so, the threaded rod 100 passes through an interior region or bore of an insert member positioned between, and concentric with, the threaded rod 100 and the body 10. The insert member is provided in the form of a central insert barrel 105 which inserts in a portion of an interior region of a bore 110_{BORE} (refer FIG. 9A) of a piston 110.

With reference to FIG. 5, the body 10 comprises a central region 115 located at or near a central area of the body's bore 10_{BORE}. The central region 115 comprises regions 115a, and 115b which are adjacent one another. Each of regions 115a, 115b represent one or more respective recesses formed in the interior walls of the bore 10_{BORE} at or near the central region 115. A lower most end 116 (with regard to the orientation shown) of the central insert barrel 105 is held in position at the central region 115 of the body 10 (see FIG. 5) by way of a circlip 120. In this manner, the central insert barrel 105 is prevented from falling from its position relative to the body 10, but allows movement of the threaded rod 100 in the vertical plane along the longitudinal axis X. In one respect, the central insert barrel 105 serves to assist in preventing leakage of fluid (which enters the body 10 via a fluid injection port 125) from the chamber 30 on movement of the piston 110 (as will be described in detail below) by way of a seal assembly 108 provided between the facing surfaces of the central insert barrel 105 and the region 115b of the central region 115. In the embodiment shown, the seal assembly 108 comprises an insert ‘O’-ring 108a, and a tack-up′ seal ring 108b, however other sealing assemblies could be devised to serve the same purpose. In the embodiment of the seal assembly 108 shown, the central insert barrel 105 operates to play a part in defining the interior chamber 30 which accommodates the fluid during operation of the load transfer assembly 25.

Adjacent the region 115b is a seat 130 (see FIG. 5) on which a base portion 110a of the piston 110 sits when the apparatus 5 is in a non-pressurised condition. As shown in FIGS. 9A and 9C, piston 110 extends upwards (in the context of the orientation shown) from its base 110a to a head portion 110b. The bore 110_{BORE} extends through the head portion 110b of the piston 110, a portion of which provides an internal thread 112a which engages with an external thread 112b provided on the exterior surface of the threaded rod 100, the engagement of the internal thread 112a and the external thread 112b both serving to form the threaded interface region 112 (shown in detail in FIG. 9C). A region of the bore 110_{BORE} of the piston 110 and a portion of the length of the shaft portion 100a of the threaded rod 100 accommodates a portion of the central insert barrel 105.

As shown in FIG. 9C, a rod seal 111 is provided between the exterior surface of the central insert barrel and an interior surface of the bore 110_{BORE} proximal the base portion 110a of the piston 110. Above the location of the rod seal 111 is a wiper seal 113.

As will be appreciated, the threaded engagement between the threaded rod 100 and the piston 110 serves to provide both components in fixed relation with one another having regard to movement along the longitudinal axis X—the threaded engagement allowing the threaded rod 100 freedom to rotate relative to the piston 110 about the longitudinal axis X of the apparatus 5 so that the threaded rod can translate along the longitudinal axis X independent of the piston 110, while providing for movement of the threaded rod 100 and the piston 110 together along the longitudinal axis X when either are in fixed relation with the other when either are caused to be moved along the longitudinal axis X. As such, movement of the piston 110 (to be described below) along the longitudinal axis X serves to also move the threaded rod 100 therewith.

With the piston 110 assembled in its position with the threaded rod 100, a distal end 145 (refer FIG. 5) of the body 10 is closed by way of a cylinder cap 150, the cylinder cap being threadedly engaged with the body 10 by way of corresponding and respective threads (110c, 145a) as shown in FIG. 9C. A wiper seal 119 is provided between the exterior surface of the head portion 110b of the piston 110 and the interior surface of a bore 150_{BORE} (refer FIG. 9C) of the cylinder cap 150. A piston seal 109 is provided between the interior surface portion of the bore 10_{BORE} of the body 10 and the exterior surface of the base portion 110a of the piston 110. In this manner, a fluidly closed cylindrical region in which the base portion 110a of the piston 110 operates is defined by (with reference to FIG. 9C) wall W₁ of the body 10, wall W₂ of the cylinder cap 150, seat region 130 of the body, and a wall W₃ of the central insert barrel 105.

For the embodiments shown in the Figures, the chamber 30 is defined by the seat 130 of the body 10, the lower (in the context of the orientation shown in the Figures) facing surface of the base portion 110a of the piston 100, and the wall W₃ of the central insert barrel 105. In this manner, the body 10 cooperates with the load transfer assembly 25 to provide the fluidly sealed chamber 30 operable for accommodating a fluid subject to a pressure, or increasing pressure. As the skilled reader would appreciate, the volume of the chamber 30 cooperatively defined by the body 10 and the load transfer assembly 25 can increase as the pressure of the fluid increases, and one or more components of the load transfer assembly moves (along the longitudinal axis X) in response to the pressurised fluid.

Accordingly, as described and shown in the Figures, interior portions of the body 10 operates with portion(s)/componentry of the load transfer apparatus 25 to define both the cylinder region and the fluid chamber 30, advantages being the ability to provide an integrated pressurisable fluid chamber for use in developing a load of sufficient magnitude to load test items appropriate for serving as lifting attachments for heavy industrial objects.

FIG. 9C also shows a degree of clearance (referenced in FIG. 9C by way of letter D′) between the upper facing surface of the head portion 110b of the piston 110 and an interior facing surface 35c of the handle 35. The magnitude of the clearance D can be dimensioned as appropriate.

The (upper) distal end 100c of the threaded rod 100 is accommodated in a recess 35d provided in an internal region of the handle 35 (recessed from interior surface 35c). The threaded rod 100 further comprises an aperture 100d provided at or near the distal end 100c and which is sized so as to be capable of receiving, in one form, a pin 100p. The handle 35 also comprises an aperture 35b which again is sized sufficient to receive the pin 100p therethrough. The threaded rod 100 is inserted into the recess 35d such that the pin 100p is able to pass through apertures 35b and 100d so as to connect or key the threaded rod 100 to the handle 35. In this manner, rotation of the handle 35 (via gripping portion 35a by a user serves to also rotate the threaded rod 100—as the threaded rod has rotational freedom about the longitudinal axis X. As the threaded rod 100 is threadedly engaged with the piston 110, rotation of the threaded rod by way of the handle 35 translates or moves the threaded rod with respect to the body 10 along the longitudinal axis X. In this manner, the starting position of the threaded rod 100, and consequently the clevis 45, can be varied as needed (generally depending on the geometry of the lift point or pad-eye to be subject to testing). Of course, the handle 35 being removable from the rod 100 (via removal of the pin 100p) allows the apparatus 5 to be readily disassembled for, for example, maintenance purposes and/or packing purposes for transportation/portability. The skilled reader would appreciate that many different arrangements could be realised that operate to key the threaded rod 100 with the handle 35, such as for example, using one or more grub or hex screws that insert through the apertures 35b provided at both sides of the lower portion of the gripping portion 35a of the handle (shown in FIGS. 1 and 6), and which each screw into respective threaded recesses (for example) provided in the threaded rod 100 at locations corresponding with the aperture 100d. In this manner, the handle 35 keys with the threaded rod 100 from opposing sides of the lower portion of the gripping portion 35a (and the threaded rod 100 at the location indicated by aperture 100d).

In one embodiment, the gripping portion 35a is configured so as to be capable of articulating (relative to the handle 35) between stowed and operable conditions such that the gripping portion 35a can be folded or retracted away (so as to reside proximal the exterior of the body 10). The skilled reader will appreciate that retraction of the gripping portion 35a to the stowed condition allows the upper region of the handle 35 to remain substantially flat which assists in reducing the overall profile or physical envelope of the apparatus 5 for packing/transportation/portability purposes.

General operation of the apparatus 5 will now be described.

Adjacent the base 110a of the piston 110 is the fluid injection port 125. The fluid injection port 125 provides the main means of injecting a suitable fluid, such as for example, a hydraulic fluid (eg. a non-compressible fluid), into the chamber 30 for acting against the piston 110 (ie. so as to facilitate, when under pressure, movement of the piston 110 and the threaded rod 100). It is noted that a compressible fluid, such as for example air, could be used for operation of embodiments of the apparatus 5. However, a pneumatic configuration has the potential to reduce the usefulness of the apparatus in that a longer period of time (as compared using a non-compressible fluid) may be needed in order for the appropriate pressure to be built up for testing purposes, and it is generally not possible to achieve the same pressure(s) possible using hydraulic arrangements. For example, embodiments arranged and tested in accordance with those described herein, operate using about 10,000 psi oil pressure, but a standard compressor will provide 100 psi of air pressure. It follows that the equivalent pneumatic arrangement would require a piston area 100 times larger than that used for a hydraulic configuration (even gas in nitrogen cylinders operate at about 2,000 psi). When requiring high pressures, safety is another concern as one is then dealing with a pressure vessel. Accordingly, while a pneumatic arrangement could be possible, embodiments tested to date have involved a hydraulic arrangement using a non-compressible fluid.

With reference to the FIG. 13, the fluid injection 125 is configured so as to deliver fluid into a channel 140, which is in fluid communication with the chamber 30. In the configuration shown in FIG. 13, fluid entering via the fluid injection port 125 fills the channel 140, the chamber 30 and, when appropriately pressurized, begins to act on the lower facing surface 130 (see FIG. 9C) of the piston 110. As the only freedom of movement of the piston 110 is, in the context of the arrangement shown in the Figures, upward along the longitudinal axis X in the direction M, increases in fluid pressure, serve to force the piston 110 upwardly which, in turn, due to the piston's threaded engagement with the threaded rod 95, facilitates movement of the threaded rod 100 in the same direction. When the clevis 45 is connected to the pad-eye P_{EYE}, and the body 10 supported (at end 15) on the surface 20 of the host object 22, relative movement of the threaded rod 95 (relative to the body 10 and the host object 22) will commence. However, such movement will be resisted by the connection (C₁, C₂) between the pad-eye P_{EYE} by way of the clevis pin 65 which will result in a load being applied to the pad-eye. As such, increased fluid pressure is needed to increase the force applied to the pad-eye P_{EYE}.

An operator of the apparatus 5 will continue to increase the fluid pressure until a designated load (that required by the applicable regulatory framework) is reached, or the connection C₁, C₂ or the pad eye itself fails.

It is noted that the general arrangement of the load transfer assembly 25 and the body 10 (notably its configuration at end 15) is adjustable so that the apparatus 5 can be used to lift points/pad-eyes P_{EYE} of different geometries. In this regard, the apertures 14a, 14b approximal end 15 of the body 10 are dimensioned so that the clevis pin 65 (and the clevis 45) can be threaded through apertures of lift points/pad-eyes that may be spaced at varying distances from the surface of the host object (to which the relevant lift point/pad-eye is connected to). Differing geometries of this type may be accommodated by threading the threaded rod 100 with the piston 110 further along the shaft portion 100a of the rod as appropriate (by way of the handle 35). As noted above, the threaded rod 100 is keyed to the handle 35 by way of pin 100p. Therefore, different spacings (with respect to the body 10) of the eyelet or aperture (A_{P}) of the lift points/pad-eyes P_{EYE} can be accommodated by the user of the apparatus 5 simply rotating the handle 35 thereby translating the threaded rod 100 along the longitudinal axis X until the apertures 50a, 50b of the clevis 45 are substantially concentric/aligned with the eyelet/aperture of the relevant lift point/pad-eye (P_{EYE}), following which the clevis pin 65 (push pin 70) can be inserted and secured in the manner described above. Thus, any variations in distance of a lifting point/pad-eyes from the surface of the host object can be readily accommodated.

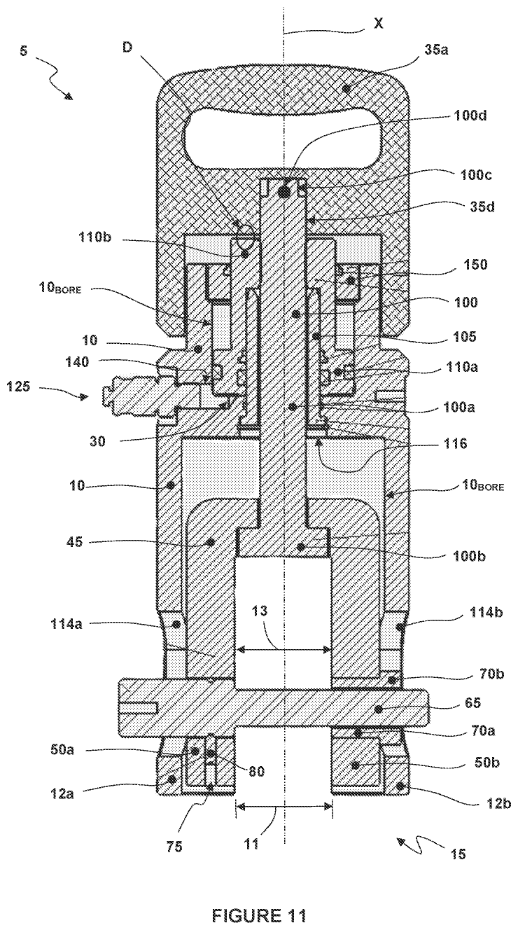

A further form 5′ of the body 10 of the apparatus is shown in FIG. 12. The substance of the arrangement is substantially the same as that shown in FIG. 11, however, the apparatus 5′ features a body 10 comprised of two separate portions, 10A and 10B which can be joined together at an interface region where both portions (10A, and 10B) are coupled or connected together so as to define the body 10; marked in FIG. 12 as ‘10A/B Interface’. A suitable coupling or connection arrangement provided at such an interface region could comprise, for example, a threaded region (shown in FIG. 12) provided at respective meeting ends of both portions 10A, 10B. Accordingly, such an arrangement (of the body 10) accords with the principles described herein; as opposed to arrangements involving a plurality of separate bodies of components effectively collocated together providing a modular configuration. It will be appreciated that the body 10 could be configured so as to be formed with any number of portions which, when assembled, operate in accordance with the principles described herein.

The principles of the embodiments of the apparatus 5 described herein may be implemented in various ways. Broadly, one such implementation may involve providing (by manufacturing, assembling, operably configuring, or otherwise) any embodiment of an apparatus configured in accordance with any of the embodiments of the apparatus 5 described herein, locating such an apparatus on the surface (20) of an object (22) so as to be substantially concentric with a target pad eye (P_{EYE}); connecting the pad eye (P_{EYE}) to the load transfer assembly 25 of the apparatus (5); and operating the apparatus so as to transfer a force to the pad eye (P_{EYE}) for testing the structural capacity of the connection C₁, C₂.

The apparatus 5 may be preferably positioned such that the first, second leg portions 12a, 12b of the body 10, and the first, second leg portions 50a, 50b of the clevis 45 substantially correspond or are substantially concentric with an aperture (A_{P}) or eyelet of the pad eye (P_{EYE}).

The load transfer assembly 25 may require adjusted so that the clevis pin 65 can be threaded (ie. passed/inserted) through the respective apertures (14a, 14b, 50a, 50b) of both the first, second leg portions (12a, 12b, 50a, 50b) of the body (10) and the clevis 45, and the aperture/eyelet (A_{P}) of the pad-eye P_{EYE}. As noted above, such adjustment may require the manual manipulation of the handle 35 so as to translate the threaded rod 100 (and consequently the clevis 45) along the longitudinal axis X of the apparatus 5 so that the respective apertures of the first, second leg portions of the body 10 and the clevis 45, and the aperture/eyelet of the pad eye are in substantial alignment of substantially concentric with one another so that the clevis pin 65 can be inserted and secured appropriately.

A fluid source is then connected to the fluid injection port 125 and a flow of fluid encouraged into the chamber 30 (for example by way of a fluid pump or similar). As the only freedom of movement of the piston 110 is along the longitudinal axis X of the apparatus 5, increases in fluid pressure serve to encourage further movement of the piston 110 which, in turn, due to the piston's threaded engagement with the threaded rod 100, facilitates movement of the rod in the same direction. As the clevis 45 is connected to the relevant pad-eye P_{EYE}, and the body 10 supported (by way of the first end 15) on the surface 20 of the host object 22, relative movement of the threaded rod 100 (relative to the body 10 and the host object) will commence. However, such movement will be resisted by the connections (C₁, C₂) between the pad-eye P_{EYE} which will result in a load being applied to the pad eye and consequently the connection (C₁, C₂). As such, increased fluid pressure is needed to increase the force applied to the pad-eye P_{EYE}, and consequently its connection to the host object 22.

An operator of embodiments of the apparatus 5 will continue to increase the fluid pressure until a designated load (that required by the applicable regulatory framework) is reached, or the connection or the pad eye itself fails.

In other forms, any of the embodiments described herein may be provided as a kit of parts comprising any of the features or components of any embodiments of the systems described herein. In this manner, the apparatus 5, either as a complete set of relevant parts or otherwise (which could be provided as supplementary kits, for example) can be provided commercially.

The skilled person would appreciate the types of materials that can be used to form any of the components of the apparatus 5 in view of the operational performance required of the apparatus. In one embodiment, the body 10 may be formed (for example, machined) from high strength steel, aluminum, titanium, as possible examples.

Those skilled in the art will readily appreciate that a wide variety of modifications, variations, alterations, and combinations can be made with respect to the above described embodiments without departing from the spirit and scope of any aspect of the principles described herein, and that such modifications, variations, alterations, and combinations are to be viewed as falling within the ambit of the inventive concept.

What is claimed:

1. A connection point test apparatus for testing the strength of an association of a connection point to an object, the connection point test apparatus comprising:
a body of single piece construction configured for placement against a surface of the object so that a reaction force can be applied by the body to the surface of the object as a reaction to a test force being applied to the connection point during operation of the apparatus; and
a load transfer assembly operable within a profile of the body, and releasably connectable to the connection point associated with the object, the load transfer assembly configured operable with the body for generating the test force for transfer to the connection point for testing its association to the object;
the body configured so that a portion thereof, cooperatively with the load transfer assembly, defines a chamber internal of the body for accommodating a fluid which, when placed under pressure, operates the load transfer assembly;
wherein the reaction force is created by operation of the load transfer assembly and is transferred directly to the surface of the object by the body.

2. A connection point test apparatus for testing the strength of an association of a connection point to an object, the connection point test apparatus comprising:
a body configured for placement against a surface of the object so that a reaction force can be applied by the body to the surface of the object as a reaction to a test force being applied to the connection point during operation of the apparatus; and
a load transfer assembly operable within a profile of the body, and releasably connectable to the connection point associated with the object, the load transfer assembly configured operable with the body for generating the test force for transfer to the connection point for testing its association to the object;
the body configured so that a portion thereof, cooperatively with the load transfer assembly, defines a chamber internal of the body for accommodating a fluid which, when placed under pressure, operates the load transfer assembly;
wherein a diameter of the connection point test apparatus is substantially the same along its length.

3. The connection point test apparatus of claim 1, wherein the body is of cylindrical or tubular form concentric with a longitudinal axis of the connection point test apparatus, the body having a bore extending therethrough defining a periphery of the bore within which the load transfer assembly operates.

4. The connection point test apparatus of claim 3, wherein the bore is configured having a narrowing portion at a region along the longitudinal axis for defining first and second portions of the bore either side of the narrowing portion, the first portion of the bore configured for providing the portion of the body which cooperates with a portion of the load transfer assembly for defining the chamber, the second portion of the bore configured for providing a region of space in which a portion of the load transfer assembly connects with the connection point.

5. The connection point test apparatus of claim 4, wherein the surface of the body configured for placement against the surface of the object is provided at an end region of the body in the form of first and second spaced apart and substantially opposing leg portions.

6. The connection point test apparatus of claim 5, wherein the load transfer assembly comprises an engager provided operable substantially within the region of space provided by the second portion of the bore of the body, the engager comprising first and second leg portions each comprising respective apertures arranged substantially concentric with one another.

7. The connection point test apparatus of claim 6, wherein the load transfer assembly comprises a rod member operable with the engager such that movement of the rod member in a direction along the longitudinal axis of the connection point test apparatus causes movement of the engager in at least said direction.

8. The connection point test apparatus of claim 7, wherein the load transfer assembly further comprises a piston operable with the rod member, the piston comprising a bore extending through the piston and through which the rod member passes so as to associate with the piston by way of a threaded engagement, such threaded engagement allowing:
(i) the rod member freedom to rotate relative to the piston about the longitudinal axis of the connection point test apparatus so that the rod member can translate along the longitudinal axis independent of the piston, while
(ii) providing for movement of the rod member and the piston together along the longitudinal axis when either are caused to be moved along the longitudinal axis.

9. The connection point test apparatus of claim 8, wherein the piston is operable with the chamber such that fluid accommodated in the chamber, when under pressure, facilitates or encourages movement of the piston along the longitudinal axis of the connection point test apparatus.

10. The connection point test apparatus of claim 8, wherein the chamber is defined by at least a portion of the narrowing portion of the bore of the body defining the first bore portion, and a portion of the piston that faces said portion of said narrowing portion.

11. The connection point test apparatus of claim 7, wherein the load transfer assembly is configured operable with a handle of said apparatus for use in facilitating translation of the rod member of the load transfer assembly along the longitudinal axis for aligning the apertures of the engager and those at said end region of the body with an aperture provided by the connection point for allowing insertion of the retaining device for connecting the load transfer assembly with the connection point.

12. The connection point test apparatus of claim 11, wherein the handle is configured of a tubular form that is substantially commensurate with the profile of the body when the handle is arranged operable with the load transfer assembly.

13. The connection point test apparatus of claim 12, wherein the handle is engageable with the rod member so that both the rod member and the handle can be provided in fixed relation with each other thereby allowing for rotation of the rod member via the handle.

14. The connection point test apparatus of claim 2, wherein the body is formed of an assembly of first and second separate parts, the first part configured so as to provide the portion of the body which cooperatively defines the chamber with the load transfer assembly, and the second part configured so as to provide the surface of the body configured for placement against the surface of the object so as to provide the reaction force to the object.

15. A connection point test apparatus for testing the strength of an association of a connection point (or similar) to an object, the connection point test apparatus comprising:
a body for applying a reaction force to the object; and
a load transfer assembly operable within a profile of the body to generate a test force;
the load transfer assembly comprising: a rod member associated with a piston by way of a threaded engagement so as to allow adjustment of the longitudinal position of the rod member relative to the piston by rotation of the rod member; and an engager, the engager being configured to be releasably connectable to the connection point so as to transfer the test force to the connection point;
wherein the piston is configured operable within the body for generating the test force, which is transferred to the engager by longitudinal movement of the rod member for testing the connection point's association to the object.

16. The connection point test apparatus of claim 15, wherein the rod member is slidably received through an aperture of the engager.

17. The connection point test apparatus of claim 15, wherein the engager is axially translatable relative to a portion of the body that is for transferring the reaction force to the object.

18. The connection point test apparatus of claim 15, wherein the load transfer assembly is configured operable with a handle such that rotation of
